(19) United States
(12) Patent Application Publication
(10) Pub. No.: US 2020/0296900 A1
(43) Pub. Date: Sep. 24, 2020

(54) Mobil device for plants

(71) Applicant: Sharolyn VETTESE, North York (CA)

(72) Inventor: Sharolyn VETTESE, North York (CA)

(21) Appl. No.: 16/824,160

(22) Filed: Mar. 19, 2020

Related U.S. Application Data
(60) Provisional application No. 62/821,113, filed on Mar. 20, 2019.

(51) Int. Cl. A01G 9/02; A01G 9/029

(52) U.S. Cl. CPC A01G 9/023; A01G 9/0299

(57) ABSTRACT

A vertical frame secured on a free-standing mobile base that has horizontal sections to which are attached removable plant bins, approximately up to 30, on the front and also the rear of the frame's horizontal sections. Each plant bin may hold one or more living plants, and the excess water level may be visible at the front of the plant bin.

### FIELD

The invention generally relates to planters for living plants, and more particularly to a free-standing mobile device for living plants.

### BACKGROUND

Living plants enhance the comfort level of people occupying a confined indoor environment that may be regulated by heating, ventilation, and air-conditioning devices providing only limited fresh air. In such a confined environment, living plants are known to remove fine airborne toxins and other volatile organic compounds from, for example, furnishings made from plastics and other artificial materials.

Living plants also increase the amount of oxygen in the indoor environment and remove carbon dioxide from the air, leading to improved well-being and alertness of workers and residents in such a confined indoor environment. Higher levels of carbon dioxide are known to cause headaches, fatigue, irritability, and lower mental concentration. Living plants also add humidity to the air, thereby reducing static electricity in the indoor environment.

When placed in front of a window, living plants may reduce energy consumption by cooling or warming the air entering the room by up to approximately 10 degrees Celsius.

Most living potted plants require soil and water, which add weight to the plants. These factors, among others, logistically restrict the location, size, and mobility of the individual potted plants.

Usually, small or medium potted living plants of varying sizes are placed on a window ledge. Large potted living plants are often placed in a fixed location on the floor because of their weight. Another way to accommodate living plants in an indoor environment is to support the plants and planting material within a support frame that is secured to a wall. Such support frames range in height from several meters (feet), to several stories. This type of living plant installation may be attached to the wall and may require computer-controlled watering, lighting, drainage, and aeration and a lift. The cost of such installations, and their regular maintenance can be very significant (e.g. in the thousands of dollars).

Regardless of size, potted living plants should be easily accessed and relocated, as required.

### SUMMARY

A mobile device for plants is provided, comprising a vertical frame; at least one horizontal member having at least one rail for supporting at least one bin; and a horizontal base for supporting the vertical frame and at least one horizontal member. The rail provides numerous points of continuous attachment the at least one bin on either side of the rail.

### BRIEF DESCRIPTION OF THE DRAWINGS

FIG. 1 is a perspective view of a mobile device for plants, according to an embodiment.

FIG. 2 is a cross-section view of the mobile device for plants through the line 2-2 shown in FIG. 1.

FIG. 3 is a detail view of region A shown in FIG. 2.

FIG. 4 is a rear view of the mobile device for plants shown in FIG. 1.

### DETAILED DESCRIPTION

The subject matter of exemplary embodiments is described with specificity herein to meet statutory requirements. However, the description itself is not intended to limit the scope of the claims.

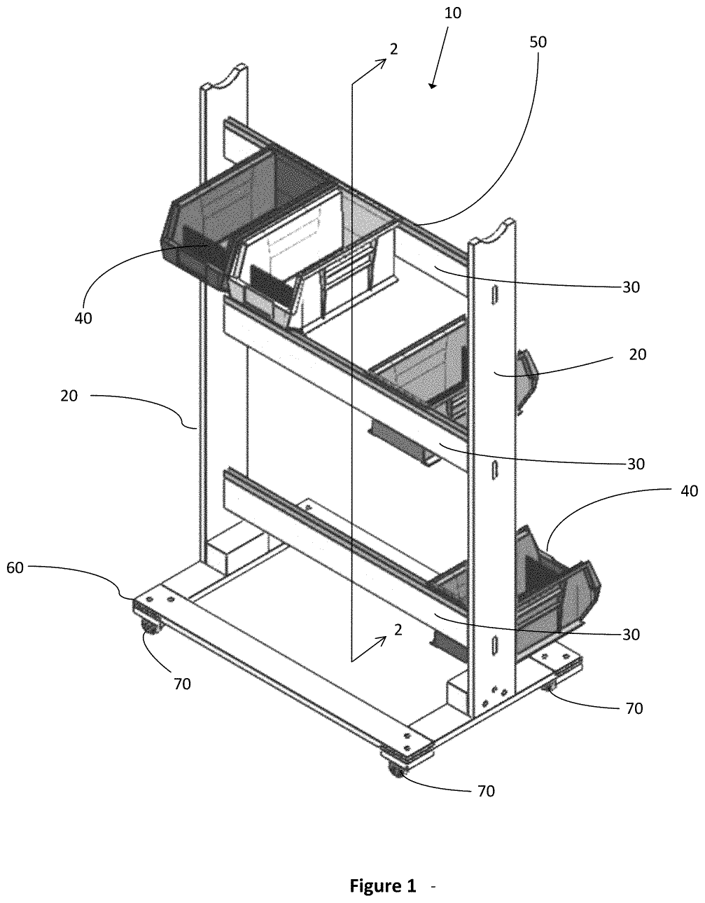

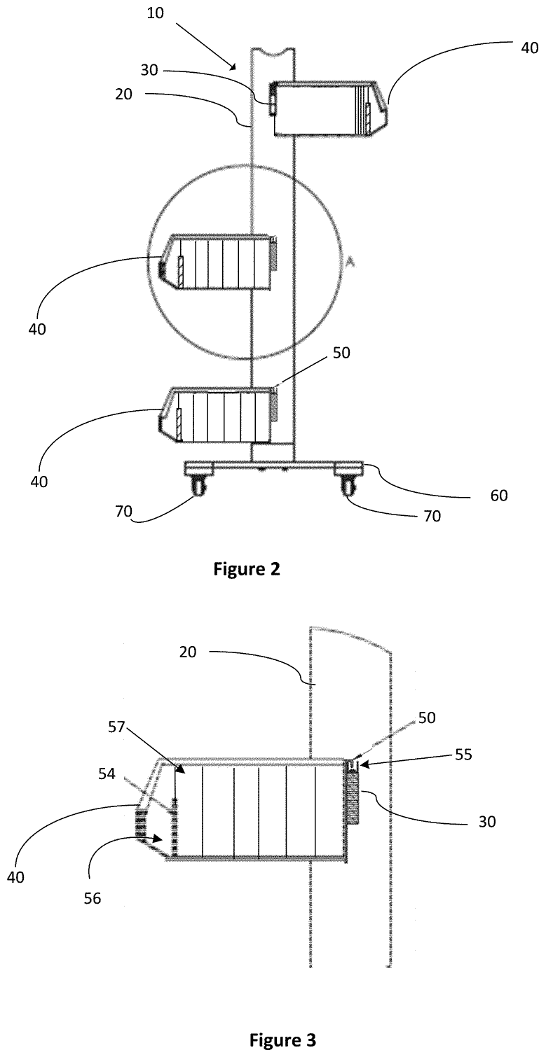

According to the embodiment shown in FIGS. 1 and 2, the mobile device for plants 10 may be a free-standing mobile device having a vertical frame 20, at least one horizontal member 30 extending between opposite sides of the frame 20, for accommodating at least one plant bin 40, and a horizontal base 60. The base 60 may be supported by a plurality of swivel wheels 70. The mobile plant device 10 may be placed in front of a window, as an alternative to traditional placement of living plants on a windowsill. Bins 40 may be accommodated on both sides of the mobile device 10 so that, for example, some bins may be adjacent a window while oppositely disposed bins 40 may face into a room. In another aspect the bins 40 may contain natural plants or artificial plants.

In the illustrated embodiment, three such horizontal members 30 are provided, each having a rail 55 capable of supporting up to five bins 40, for a total of fifteen bins. A person of skill in the art will appreciate that a greater or lesser number of bins 40 may be accommodated depending on the size of the bins 40, number of horizontal members, 30, etc. In preferred embodiments, the number of bins may range from two to thirty, and preferably from four to twenty-four, and more preferably from six to eighteen.

Each plant bin 40 is removeable by lifting it up from horizontal member 30, and may be returned to the horizontal member 30 by aligning a rear lip 50 thereof to the rail 55 of the horizontal member 30 and then may be dropped into place, as shown in the detail view of FIG. 3. Each horizontal member 30 may include a pair of rails 55, one disposed at the front and another at the rear of the horizontal member, so that plant bins 40 may be attached on both sides of the horizontal member 30. In cross section, the rail 55 may be in the shape of U-channel on a top surface of the horizontal member 30. The rail 55 may be fitted and secured to the horizontal member 30 using at least one fastener such as bolt or screw.

The approximate weight of the plant bins with plants, soil, and water may depend on the type of soil and other components used, but in a typical installation may range from 80 lbs. to 90 lbs.

The mobile plant device 10 is uncomplicated to assemble as it may not require any specialized skills, or tools. Also, no electrical or plumbing connections may be required such that the living plants housed within bins 40 may only require minimal maintenance.

The four-swivel wheels 70 facilitate mobility of the mobile plant device 10, such as changing orientation of the device, for example from front-to-back, or alignment of the mobile plant device 10 with internal architecture or room design, to permit even growth of the living plants in natural sunlight without any need to physically move the individual plants, or plant bins 40. The position of the plant bins 40 is adjustable by sliding along the rail 55 of the horizontal member 30. In embodiments, the swivel wheels may have an optional braking feature.

It will be appreciated that the types of living plants that may be planted in bins 40 is generally unrestricted. For example, spider plants have been used and may be effective air purifiers

In embodiments, the mobile device 10 may be constructed from one or more materials including but not limited to wood selected from solid wood such as pine, cherry or maple or any artificial material or synthetic material or metals selected from but not limited to steel, aluminum or other appropriate metal of material produced.

The mobile plant device 10 may have one or more points of assembly as desired and wherein the vertical frame 20 may be secured to the horizontal members 30 using securing elements such as screws and bolts.

In embodiments, such as shown in FIG. 3, the bin 40 may include an adjustable divider 54, that can be positioned within any of a plurality of vertical slots 57 in opposite sides of the bin 40 for separating the living plant and its growing medium from a well 56 for excess water that may be collected at the front of the plant bin 40, while permitting the water level to be visible from the front of the plant bin 40. In yet another aspect, the bins 40 may be colored as desired.

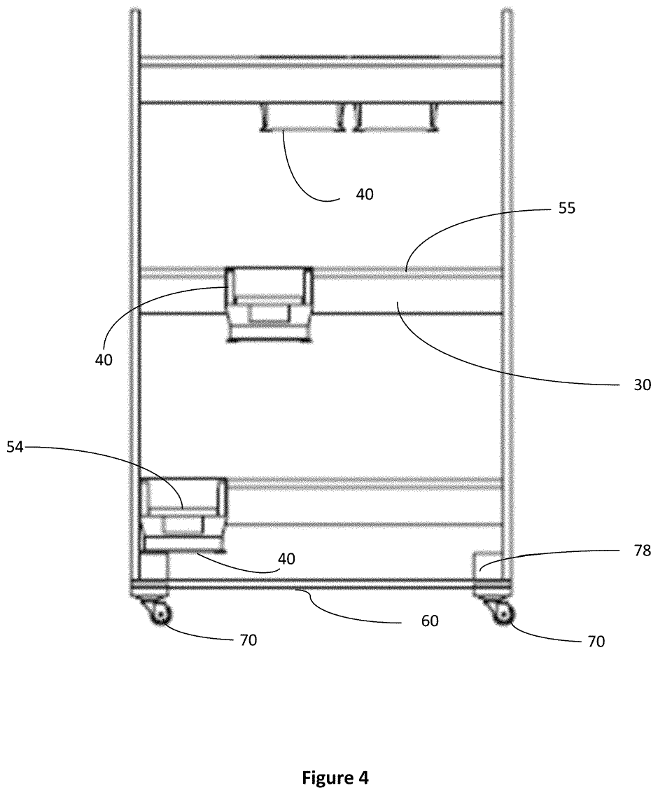

As shown in FIG. 4, the base 60 of the mobile device 10 may contain dowels 78, which may be made of wood, or a similarly complimentary material, that may secure the horizontal members 30 to the base 60.

In another embodiment, the base 60 may be glued to the vertical frame 20 at the point of attachment to the base.

A person of skill in the art will understand that the mobile device for plants 10 is not limited to living space, such as homes, offices, retail stores, lobbies, schools, hospitals, and other indoor spaces or outdoor spaces as desired, and that the bins 40 may serve purposes other than to hold living plants, for example as storage bins for keys, wallets, etc. Other applications of the mobile device 10 include use as a room divider or privacy screen. Also, two or more mobile devices 10 may be placed side-by-side either unconnected, or connected with an attachment, to provide a longer continuous wall.

Additional embodiments and variations are possible within the sphere and scope of the appended claims.

1. A mobile device for plants comprising:
a) a vertical frame;
b) at least one bin;
c) at least one horizontal member having at least one rail for supporting the at least one bin; and
d) a horizontal base for supporting the vertical frame and at least one horizontal member.

2. The mobile device as claimed in claim 1, further including a plurality of swivel wheels on the horizontal base, to facilitate moving the mobile device.

3. The device as claimed in claim 1 wherein the plurality of swivel wheels includes a braking feature.

4. The mobile device as claimed in claim 1, wherein the vertical frame is secured to the horizontal base by at least one dowel.

5. The mobile device as claimed in claim 1 wherein the at least one bin includes an adjustable divider that can be positioned in one of a plurality of slots on opposite sides of the for separating a first portion of the bin for accommodating a plant and its growing medium from a second portion of the bin for holding water.

6. The mobile device as claimed in claim 1 wherein the at least one bin is coloured.

7. The mobile device as claimed in claim 1, wherein the bin includes a lip for engaging the rail of the horizontal member.

8. The mobile device as claimed in claim 1, wherein each horizontal member includes a pair of rails for supporting multiple bins on opposite sides of the mobile device.

9. The mobile device as claimed in claim 8, wherein the bin includes a lip for engaging one of the pair of rails

10. The mobile device as claimed in claim 8, wherein the pair of rails forms U-channel on a top surface of the horizontal member.

11. The mobile device as claimed in claim 1 wherein each bin includes an adjustable divider.

12. The mobile device as claimed in claim 1 wherein the vertical frame, horizontal member and the horizontal base are fabricated from at least one material selected from wood, metal or synthetic material or combinations thereof.
